(19) United States
(12) Patent Application Publication
(10) Pub. No.: US 2012/0181846 A1
(43) Pub. Date: Jul. 19, 2012

(54) OMNI-DIRECTIONAL WHEEL

(76) Inventor: William Liddiard, London (CA)

(21) Appl. No.: 13/261,181

(22) PCT Filed: Oct. 12, 2010
(86) PCT No.: PCT/CA2010/001628

§ 371 Date: Feb. 16, 2012

(30) Foreign Application Priority Data
Oct. 9, 2009 (CA) 2,689,706

(51) Int. Cl. B60B 19/12; B60C 11/00; B60C 7/00; B29D 30/02

(52) U.S. Cl. 301/5.23; 156/112; 152/209.1

(57) ABSTRACT

An omni-directional wheel has a rim for mounting a tire, a hub for rotatably attaching the wheel to a vehicle, and a means for connecting the rim and the hub. The rim of the wheel has a part which is rotatably connected to the hub and which, when radially rotating around the hub, engages the surface of the tire mounted on the rim for rolling the tire on the rim. Thus, when the wheel is engaging the ground, the tire rolling on the rim causes a side movement of the wheel in a plan orthogonal to the normal plan of rotation of the wheel when attached to the vehicle. A solid-core tire for use with the omni-directional wheel has treads patterns or a helical coil shape for engaging the rotatable part of the rim. A method for manufacturing a solid-core tire is also provided.

### FIELD OF THE INVENTION

The invention relates to the structure and operation of wheels. In particular, the invention relates to an omni-directional wheel for controlled motion of a vehicle in any direction.

### BACKGROUND OF THE INVENTION

There have been various developments within the prior art, where attempts have been made to provide wheels capable of providing controlled motion of a vehicle in any direction. For example, U.S. Pat. No. 7,641,288, issued Jan. 5, 2010 (Baker et al.) discloses an omni-directional wheel, that when mounted on the four corners of a frame and independently driven allow for omni-directional movement of the mounting frame. The omni-directional wheel design allows the use of two identical stampings or molded bases with key holes and locating posts diametrically opposed, assembled back to back with elastomeric or rubber outer rollers mounted in between at an angle to the axis of rotation.

U.S. Pat. No. 6,547,340, issued Apr. 15, 2003 (Harris) discloses an omni-directional wheel for an omni-directional vehicle that exhibits constant ride height, low vibration, and reduced maximum ground contact pressure. The omni-directional wheel consists of a wheel assembly rotatably connected to the omni-directional vehicle chassis. The wheel assembly includes a hub on which free spinning rollers are rotatably mounted at an angle to the wheel axis. Another patent issued to Harris is U.S. Pat. No. 6,796,618 disclosing a method for designing an omni-directional wheel.

U.S. Patent Application No. 2002/0153205, published Oct. 24, 2002 (Zinanti) discloses an omni-directional wheel having a frictional bias which favors a forward and backward motion over a side-to side motion. The omni-directional wheel includes a frame having an upper portion for affixing the frame to an under-side of a weight bearing surface, at least two walls, and a central cavity defined by the side walls for receiving at least one spherical wheel, and at least two wheel bearings connected in axial alignment to the side walls for rotation of the wheel about a fixed axis.

U.S. Pat. No. 4,223,753, issued Sep. 23, 1980 (Bradbury) discloses an apparatus for producing or measuring omni-directional motion of the apparatus upon a relatively smooth but not necessarily planar surface and/or for producing or measuring omni-directional movement of the surface relative to the apparatus. The transport device includes a frame and at least two wheels having peripheral rollers, the wheels rotating about non-parallel axes. Any desired movement of the device relative to a given surface can be achieved by appropriate rotational inputs to the wheels.

There are known issues surrounding the prior art designs of omni-direction wheels. In particular, the prior art wheels designs which rely on many small wheels or rollers arranged in a substantially circular structure forming a larger wheel are known to have limited transit speeds due to uneven ride and vibrations, especially under heavy load. Further, the use of such wheels may be severely limited on certain surfaces and under adverse weather conditions by virtue of an uneven contact with the surface.

Moreover, the designs involving many small wheels or rollers appear overly complex and consist of many parts which may be prone to mechanical failure or require heavy maintenance. Additionally, such wheels appear to have restrictive loads due to many connecting joints. Accordingly, it may be desirable to provide an omni-directional wheel which is simple in design and is adequate and ready for use in a vast range of vehicles without significant changes to the existing chassis or drive mechanism of the vehicle.

### SUMMARY OF THE INVENTION

It is, thus, an object of the present invention to provide an omni-directional wheel which addresses the deficiencies found within the prior art.

The present invention overcomes the aforementioned deficiencies by the nature of its design and operation.

According to an embodiment of the present invention there is provided, an omni-directional wheel including a rim for mounting a tire; a hub for rotatably attaching the wheel to a vehicle; and a means for connecting the rim and the hub, the rim having a part which is rotatably connected to the hub and which, when radially rotating around the hub, engages the surface of the tire mounted on the rim for rolling the tire on the rim, whereby, when the wheel is engaging the ground, the tire rolling on the rim causes a side movement of the wheel in a plan orthogonal to the normal plan of rotation of the wheel when attached to the vehicle.

According to another embodiment of the present invention there is provided, a solid-core tire, for use with the omni-directional wheel. The tire can have tread patterns, or a threaded surface or a helical coil shape.

According to still another embodiment of the present invention there is provided a method for manufacturing a circular tubular solid-core tire, with or without compression grooves, or a tire having a helical coil shape, the method comprising the steps of: forcing a tire composition in a die or molding apparatus having a pattern of screw-like grooves or cavities cut or drilled therein, the die or molding apparatus being shaped so as the produced tire has a tubular shape and a straight form; curing the tire composition and removing the straight form tire from the die or molding apparatus; and bringing the two ends of the straight form tire together and tightly join or fuse the two ends of the tire so as to form the circular tubular tire having a smooth circular shape, with or without compression grooves, or the tire having the helical coil shape.

### BRIEF DESCRIPTION OF THE DRAWINGS

The present invention will be further understood from the following detailed description of preferred embodiments of the invention in conjunction with the accompanying drawings, in which:

FIG. 1 is a front view of the wheel assembly with a solid-core tire according to an embodiment of the invention;

FIG. 2 is a rear view of the wheel assembly of FIG. 1 with encased tire coil;

FIG. 3 is a cross-sectional view of the wheel assembly and tire of FIG. 1;

FIG. 4 is side view of the wheel assembly of FIG. 1 without the tire;

FIG. 5 is a is a cross-sectional view of a two-wheel assembly and tires according to another embodiment of the invention;

FIG. 6 is a side view of the two-wheel assembly of FIG. 5 without the tires;

FIG. 7 is a top plan view of a straight-form tire according to an embodiment of the invention;

FIG. 8 is a side view of a solid-core tire showing a reinforcing ring;

FIG. 9 is a view of a straight-form rubber-encased coil;

FIG. 10 is a view of the coil of FIG. 9;

FIG. 11 is a view of a tire obtained from the rubber-encased coil of FIG. 9; and

FIG. 12 is a side cross-sectional view of FIG. 6 showing the internal mechanism inside the wheel's hub according to an embodiment of the invention.

### DETAILED DESCRIPTION OF THE INVENTION

A better understanding of the present invention and its objects and advantages will become apparent to those skilled in this art from the following detailed description, wherein there are described preferred embodiments of the invention, simply by way of illustration of one mode contemplated for carrying out the invention. As will be realized, the invention is capable of modifications in various obvious respects, all without departing from the scope and essence of the invention. Accordingly, the description should be regarded as illustrative in nature and not as restrictive in any way.

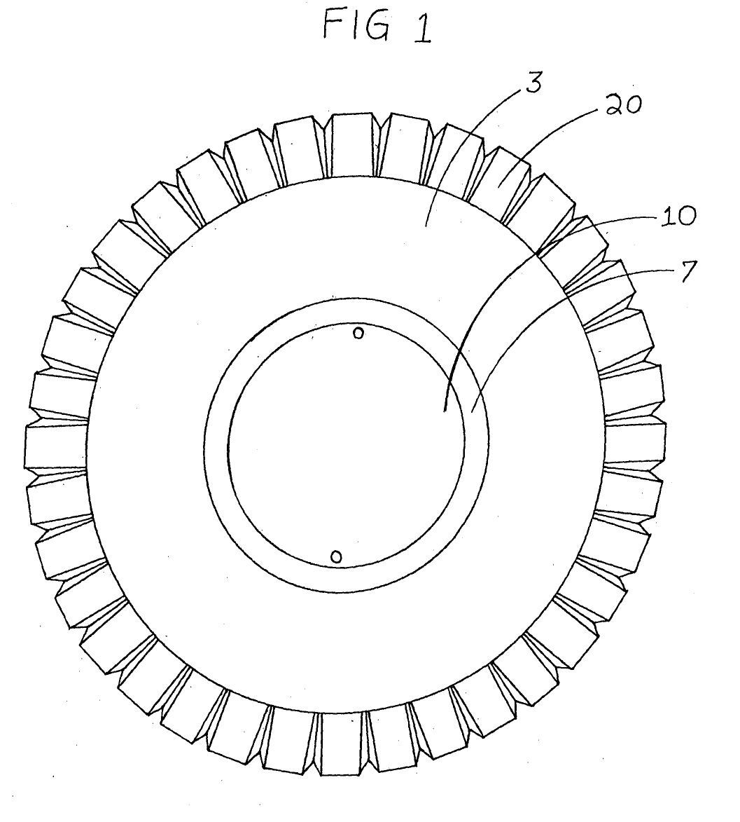

Referring to FIG. 1, shown is a front view of an omni-directional wheel according to an embodiment of the invention having an outer hub 7, a rotatable outer rim 3, and a solid-core tire with compression grooves 20. A hub access plate 10 is provided for accessing the internal mechanism of the wheel.

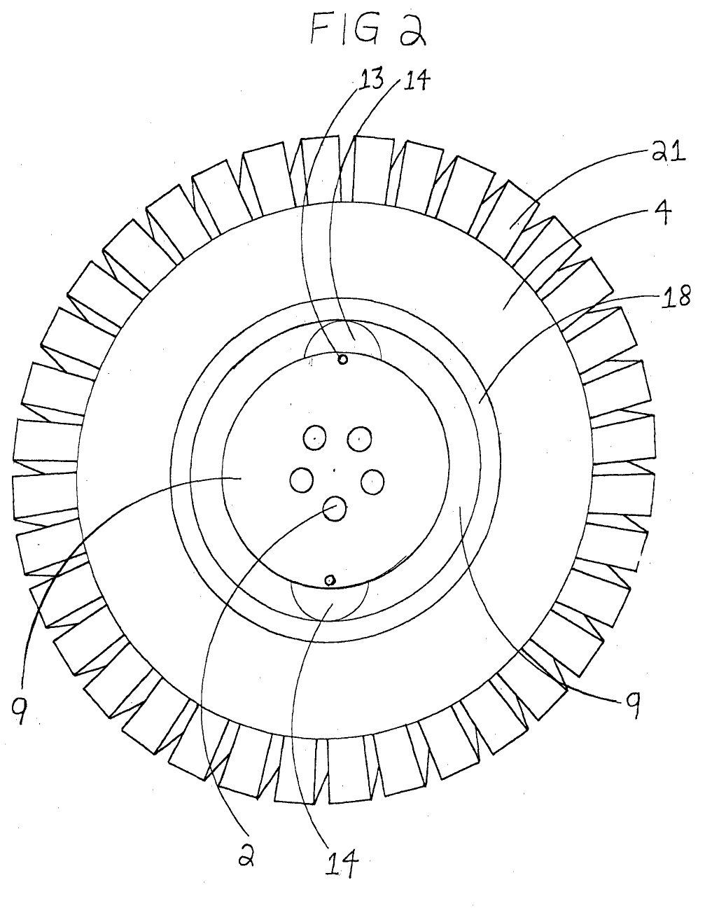

Referring to FIG. 2 shown is a rear view of the omni-directional wheel of FIG. 1 having an inner hub 9, a rotatable inner rim 4, and an encased coil tire 21. A rim drive gear 18 can be used to transfer the rotational motion from a motor to the inner rim 4. The rim drive gear 18 can be actuated by one or more pinion gears 14, each being rotatably connected to the wheel assembly, for example, by means of a pinion gear bolt 13. FIG. 2 shows an embodiment in which pion gears 14 can be provided for actuating the rim drive gear 18 and, thus, effecting rotation of the inner rim 4. A plurality of lug nut holes 2 can be provided on the inner hub 9 for attaching the wheel to a vehicle.

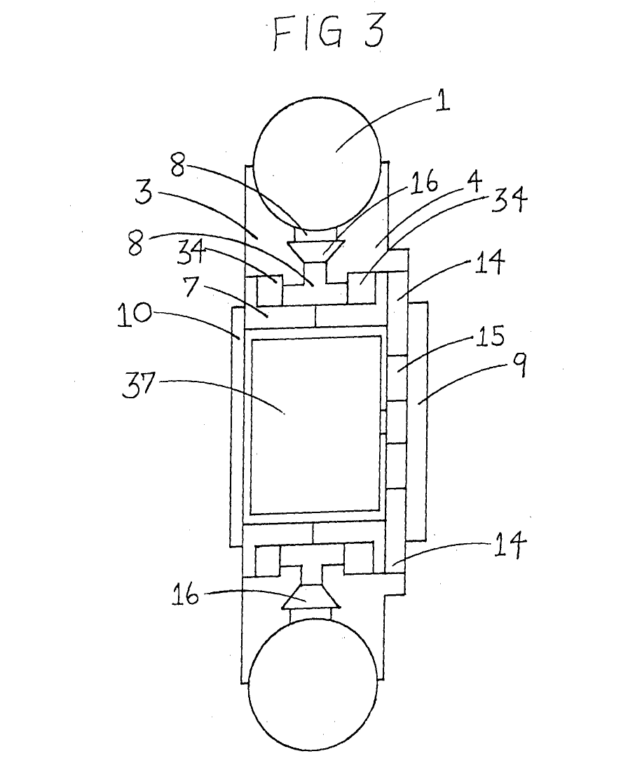

Referring to FIG. 3, shown is a cross-sectional view of the wheel assembly and tire of FIG. 1. In an embodiment of the present invention, inside the wheel assembly, particularly inside the wheel hub, there can be provided a motor 37 for actuating the rotation of the inner rim 4. In one embodiment, the motor 37 can be connected to a drive gear 15, which meshes with the pinion gears 14. Each pinion gear 14 is engaging the inner rim drive gear 18 for rotation of the inner rim 4, with respect to the axis of the wheel assembly. As the inner rim 4 is turned, bevel gears 16 housed in the braking disk 8 contact the rim gears 17 on each rim 3,4, thus effecting rotation of the opposing rim 3.

The rims 3,4 can be selectively fixed against rotation by bevel gears 16 connected to a hub braking disk 8. The hub braking disk 8, which is stationary to the hub 7,9 is provided for transferring braking energy and acceleration torque from the hub 9 to the tire 1, and from the tire 1 to the hub 9, while minimizing strain on the rims 3,4, and gears 14,15,16,17,18, which can be provided for effecting rotation of the rims 3,4.

In a preferred embodiment, the motor 37 may be turned around and be attached to a large hub access plate (not shown), which moves independently of the hub 7, and is attached to the outer rim 3.

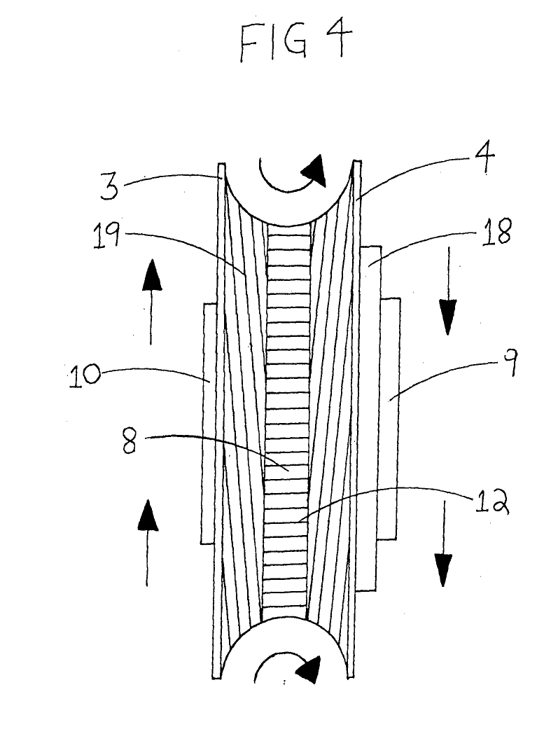

Referring to FIG. 4, shown is a side view of the wheel assembly without a tire 1. The tire 1 is supported entirely by the screw-like threaded pattern of the rims 3,4, so as, when the rims 3,4 are rotating about the axis of the wheel which is defined, for example, by the secondary drive shaft 38, the tire 1 revolves around its axis, defined, for example, by the reinforcing ring 26, causing the ground engaging wheel assembly to move sideways, parallel to the wheel axis in a plan orthogonal to the normal plan of rotation of the wheel when attached to a vehicle. The revolution of the tire 1 around the axis defined by the reinforcing ring 26 can be reversed by reversing the rotation of the rims 3,4. The hub braking disk 8 can be provided with braking threads 12 in the form of horizontal grooves, which can be sized and structured to minimize friction during side-rolling of the tire 1 and also for preventing the tire 1 from accidentally sliding around the braking disk 8 as braking pressure or directional torque builds.

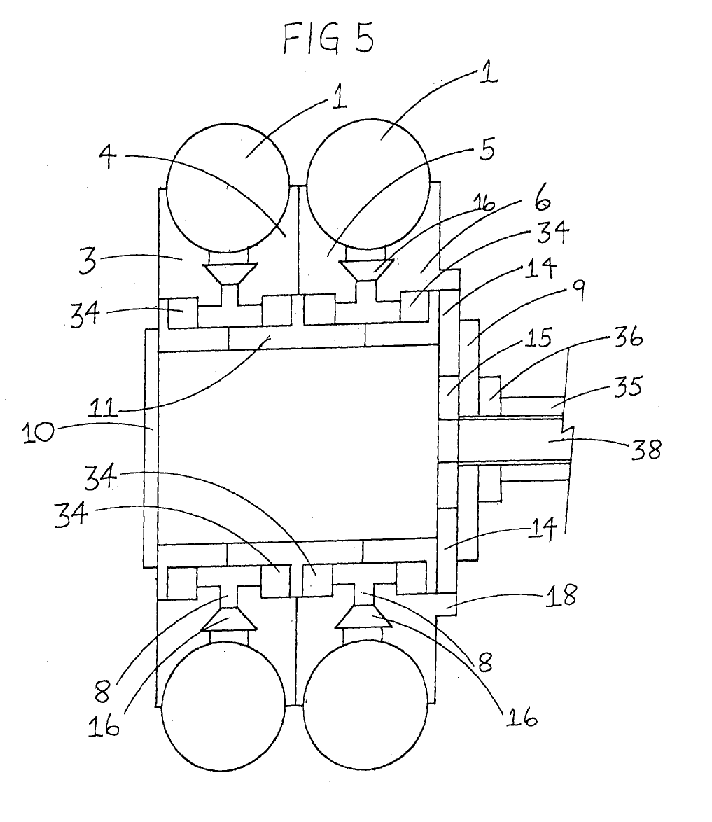

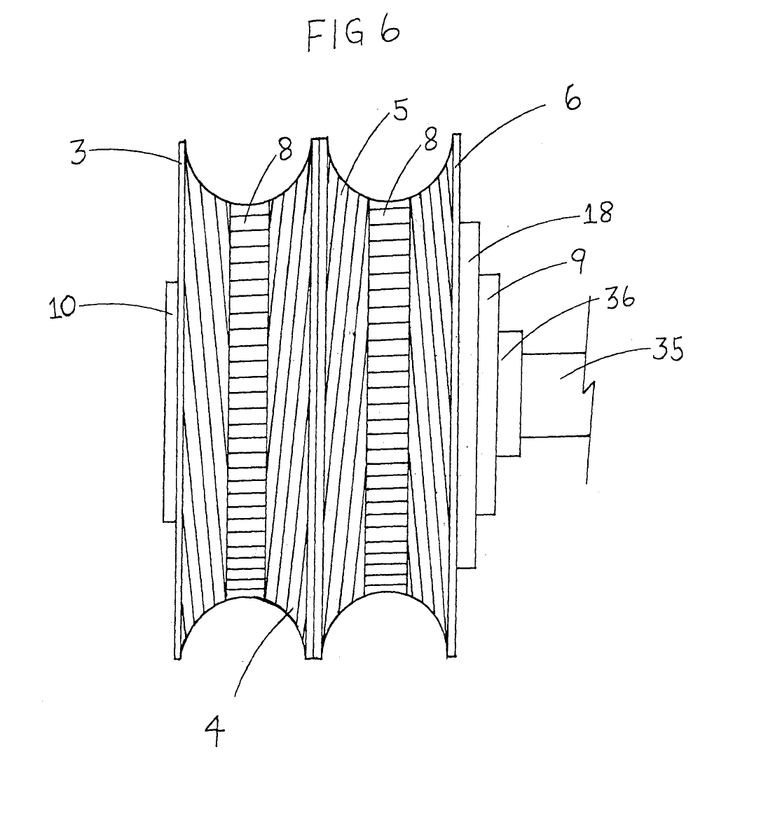

Referring now to FIGS. 5 and 6, shown are, respectively, a cross-sectional view and a side view of a two-wheel assembly and tires according to another embodiment of the invention. The two-wheel assembly can be designed with one motor 37 connected to a drive shaft 35 that extends through a drive shaft plate 36. In the case of the two-wheel assembly the inner rotating rim 6 and the outer rotating rim 3 are each separately connected to one of the two tires 1. Further, the two-wheel assembly comprises a reverse thread inner rotating rim 4 and a reverse thread outer rotating rim 5.

The configuration of the two-wheel assembly is similar to that of the above-detailed one-wheel assembly and comprises, inter alia, a central hub 11, two hub braking disks 8, and gear mechanisms associated therewith for operation of the wheel and the two tires in a similar manner, by effecting a rotation of the rims 3,4,5,6 such that the two tires roll about their axis for displacement of the ground engaging two-wheel assembly sideways or in direction parallel to the drive shaft 35.

A coating or lubrication can be applied to the surface of the rim, as known to one skilled in the art of the invention. The reinforcing ring can be lubricated to minimize friction.

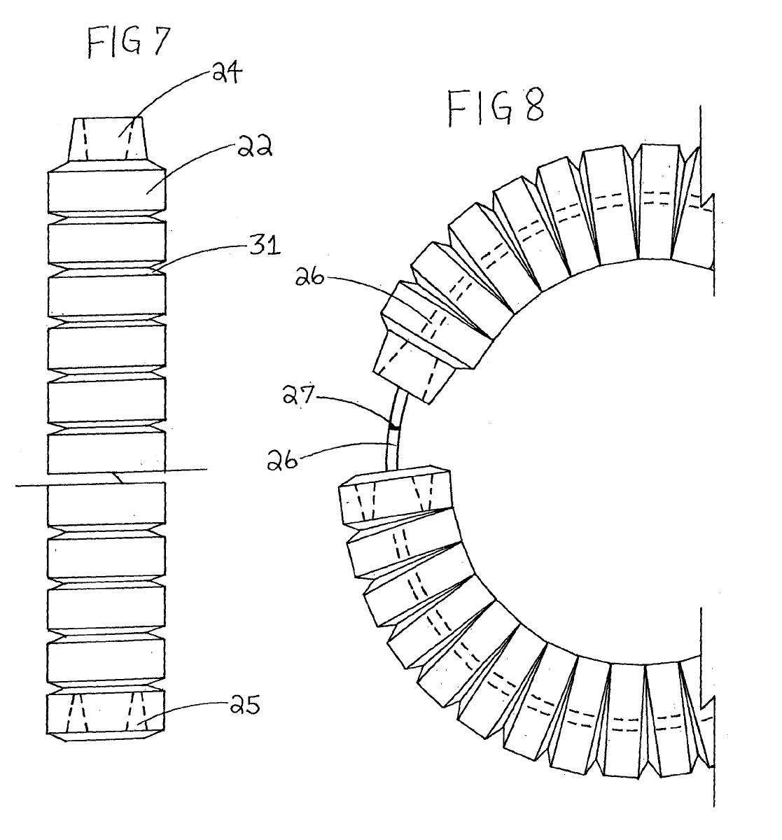

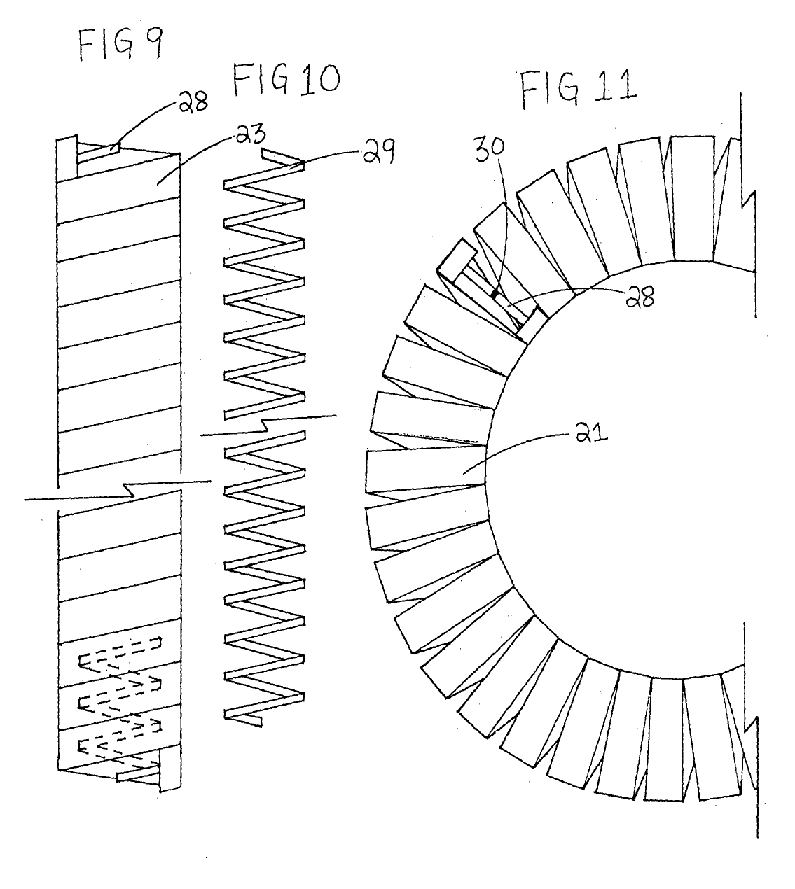

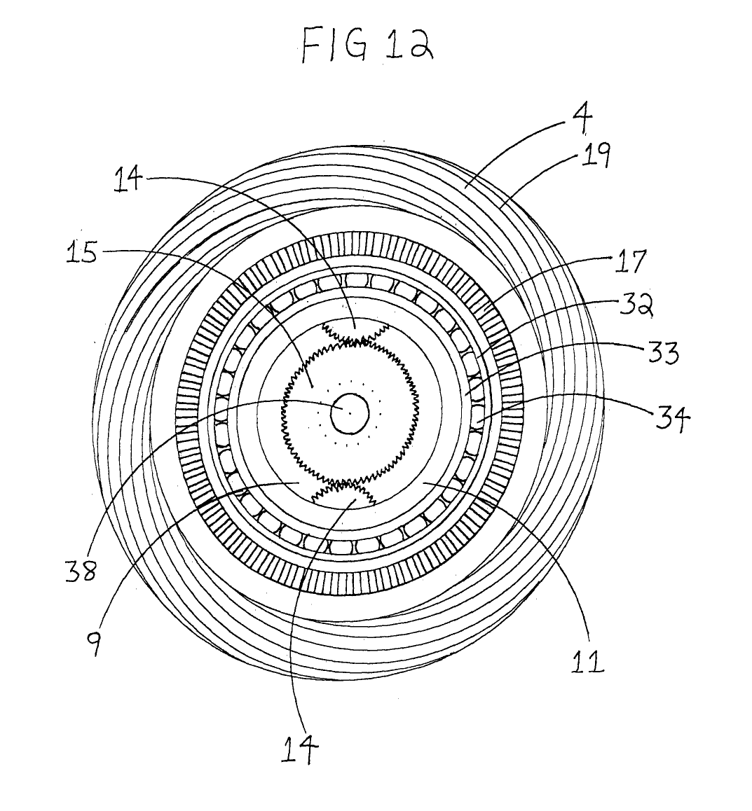

Referring now to FIGS. 7-11 shown are exemplary tires suitable for use in the present invention. Tires suitable for use in the present invention include, but are not limited to, solid-core tires 20, encased-coil tires 21, or, for some applications, a pneumatic tire (not shown). The tires are preferably manufactured in a straight form 22,23 for minimizing roll resistance. In a preferred embodiment, the straight form tire can be provided with a male overlap end portion, for example, in the form of an aperture 25 for tightly receiving the flange 24, when the two ends of the tire are aligned and tightly joined or attached together so as to create a circular tire having a tubular form. However, any other means or methods for joining the two ends of the straight-form tire can be employed in order to achieve the results of the present invention. This method of manufacturing a circular tire having a tubular form can provide consistent and uniform tension throughout the revolution of the side-rolling tire on the counter-rotating rims 3,4,5,6.

Preferably, a lubricated reinforcing ring 26, can be inserted inside the solid-core tire and fused separately along with the ends of the tire by a suitable means such as, for example, bonding, welding, etc.

In another embodiment, the encased-coil tire 21 can be manufactured in a similar way from a straight form to a circular form by joining or fusing the ends together in any manner known to a person having a skill in the art of the present invention. The encased-coil tire 21 can have the individual coil circumference encased, i.e. allowing gaps to open on the outer tire surface, while the inner tire surface is compressed, or the coil in its entirety may be encased in a solid core fashion. The encased-coil tire 21 can also be reinforced with a double opposing helical mesh, such as, for example, a spiral-wound wire or any other suitable material. Various combinations of tire embodiments can be used alternatively to create a suitable tire for its intended application, for example, but not limited to, an encased coil tire 21 having a reinforcing ring 26.

In another embodiment, the tire 1 tread patterns may include compression grooves and/or force amplifying helical grooves aligned with the threads of the rims 3,4,5,6. The grooves may be oriented concentrically, longitudinally or angularly as known to a person skilled in the art of the invention so as to maximize the torque transmitted to roll the tire 1 on the rim 3,4,5,6 and to minimize the side-rolling resistance of the tire 1. Alternatively, the traction, compression and force amplifying effects can be assisted by providing a pattern of indentations or protuberances on the surface or portions of the surface of the tire 1.

Referring to FIG. 12, shown is a side cross-sectional view of FIG. 6. In this embodiment the rims 3,4,5,6 are supported on a bearing arrangement 34, with bearings between a bearing outer race 33 and a bearing inner race 32.

In a preferred embodiment, screw-like thread patterns are provided on the surface of the rim 3,4,5,6 and the braking disk 8 for the area being in contact with the tire 1. The tire 1 is supported entirely on screw-like threads of the rim 19 and braking disk 8 to minimize friction, by use of reduced material contact between the rotatable rim 3,4,5,6, braking disk 8, and tire 1. A single screw-like thread or multiple screw-like threads may be used for larger axial movement of the tire 1. Multiple start threads on the rim may also incorporate differences in height or spacing, or both, optimized so as to roll the tire 1 to effect sideway movement of the ground engaging single or multiple wheel assembly.

Any suitable materials can be employed for the tire construction and manufacture, such as, for example, natural or synthetic rubber, and additives, such as, for example, carbon black and silica along with activators, antioxidants, and antiozonants.

Solid body parts such as, for example, the wheel hub 11, braking disk 8, movable rims 3,4,5,6, gears, reinforcing ring 26 and coil 28 can be made of metallic, composite, plastic, or other suitable material selected according to the intended application by a man of ordinary skill in the art of the present invention.

Modifications, variations, and adaptation of the embodiments of the present invention described above are possible within the scope of the invention which is defined by the claims appended hereto.

### INDUSTRIAL APPLICABILITY

The present invention provides an omni-directional wheel. Benefits derived from the use of the present invention can be enjoyed, for example, in the construction of vehicles capable of controlled motion in any direction, in connection with, for example, military, commercial, industrial, medical, and recreational applications.

The embodiments of the present invention in which an exclusive property or privilege is claimed are defined as follows:

1. An omni-directional wheel comprising:
a hub for rotatably attaching the wheel to a vehicle;
a rim for mounting a tire, the rim circumscribing the hub and being connected to the hub,
the rim having an annular member which is rotatably connected to the hub and which, when radially rotating around the hub, engages the tire mounted on the rim for rotating the tire on the rim about the circumferential axis of the tire,
whereby, when the wheel is engaging the ground, the tire rolling or rotating on the rim about the circumferential axis of the tire causes a sideway movement of the wheel in a plan substantially orthogonal to the normal plan of rotation of the wheel when attached to the vehicle.

2. An omni-directional wheel according to claim 1, wherein the rim has two annular members which are rotatably connected to the hub, the two members rotating in opposite directions for engaging the tire for rotating the tire on the rim about the circumferential axis of the tire.

3. An omni-directional wheel according to claim 2, wherein the hub has a
stationary braking means disposed centrally between the two rotatable members of the rim.

4. An omni-directional wheel according to claim 2 or 3, further comprising an actuating means for rotating at least one of the two rotatable members of the rim.

5. An omni-directional wheel according to claim 2 or 3, further comprising an actuating means for rotating the two rotatable members of the rim in opposite directions.

6. An omni-directional wheel according to claim 4 or 5, further comprising a gear mechanism for transferring rotational motion from the actuating means to the rotatable rim members for rotating the tire about the circumferential axis of the tire.

7. An omni-directional wheel according to any one of claims 4 to 6, wherein the actuating means is a motor inside the wheel hub.

8. An omni-directional wheel according to any one of claims 3 to 7, wherein the braking means has braking threads.

9. An omni-directional wheel according to claim 8, wherein the braking threads are horizontal grooves.

10. An omni-directional wheel according to any one of claims 1 to 9, wherein the rim has a threaded pattern or grooves for supporting the tire and for engaging the tire for rotation about the circumferential axis of the tire.

11. An omni-directional wheel according to claim 10, wherein the threaded pattern of the rim is screw-like.

12. An omni-directional wheel according to any one of claims 1 to 11 further comprising a tire selected from the group consisting of solid core tire, encased-coil tire, and pneumatic tire.

13. An omni-directional wheel according to claim 12, wherein the surface of tire has tread patterns aligned with the threaded pattern or grooves of the rim.

14. An omni-directional wheel according to claim 13, wherein the tread patterns on the surface of the tire are compression grooves, force amplifying helical grooves, or combinations thereof.

15. An omni-directional wheel according to claim 13 or 14, wherein the tread patterns on the surface of the tire are oriented concentrically, longitudinally, angularly, or combinations thereof.

16. An omni-directional wheel according to any one of claims 13 to 15, wherein the surface of the tire has a pattern of indentations or protuberances for traction, compression, and force amplifying effects.

17. An omni-directional wheel according to any one of claims 1 to 16, wherein the rotatable member of the rim is supported on a bearing arrangement connected to the hub.

18. A method for manufacturing a solid-core tire having a treaded pattern surface or a helical coil shape for use with the omni-directional wheel of claim 1, the method comprising the steps of:
forcing a tire composition in a die or molding apparatus having a pattern of grooves or cavities, the die or molding apparatus being shaped so as the produced tire has a tubular shape and a straight form;
curing the tire composition and removing the straight form tire from the die or molding apparatus; and
bringing the two ends of the straight form tire together and tightly join or fuse the two ends of the tire so as to form a circular tubular tire.

19. The method according to claim 18, wherein a reinforcing material is inserted into the tire composition and is co-cured with the tire during molding of the tire.

20. A solid-core tire having a treaded pattern surface or a helical coil shape for use with the omni-directional wheel of any one of claims 1 to 18.
